(19) United States
(12) Patent Application Publication
(10) Pub. No.: US 2004/0267450 A1
(43) Pub. Date: Dec. 30, 2004

(54) Method of determining locomotive orientation based on magnetic compass reading, GPS, and track layout

(75) Inventor: Jeffrey D. Kernwein, Cedar Rapids, IA (US)

Correspondence Address: WEBB ZIESENHEIM LOGSDON ORKIN & HANSON, P.C., 700 KOPPERS BUILDING, 436 SEVENTH AVENUE, PITTSBURGH, PA, 15219, US

(73) Assignee: WESTINGHOUSE AIR BRAKE TECHNOLOGIES CORPORATION

(21) Appl. No.: 10/611,285

(22) Filed: Jun. 30, 2003

(51) Int. Cl. G01C 21/00

(52) U.S. Cl. 701/213; 701/19; 342/357.08

(57) ABSTRACT

A method of determining locomotive orientation based on magnetic compass reading, GPS, and track layout includes the steps of determining a global position and a heading of a locomotive. Upon determining the global position and heading, it is necessary to communicate these to a track database disposed in a computer located in a predetermined location. The track database also includes a parallel line substantially identical to a predetermined track layout within the track database for comparing the determined global position and heading to the parallel line for deriving an actual orientation of a locomotive.

### FIELD OF INVENTION

The present invention relates, in general, to locomotive management and, more specifically, to determining the orientation of a locomotive on a section of track without requiring motion from the locomotive.

### BACKGROUND OF THE INVENTION

Prior to the present invention, as is generally well known within the rail industry, train management systems possessing the capability to determine locomotive orientation require the use, of a global position system (GPS), track circuits, and/or track transponders. The orientation is conveyed to locomotive management for the purpose of planning and building trains with confidence about the orientation in the train consist, specifically the lead locomotive. Presently GPS provide the location of locomotives, but alone GPS cannot provide orientation. If the locomotive is moving, direction of travel can be obtained from GPS but knowledge of “short hood” orientation and reverser setting is required to determine actual locomotive orientation. Without motion, orientation cannot be resolved even if short hood and reverser status is known.

### SUMMARY OF THE INVENTION

The present invention provides a method of determining locomotive orientation based on magnetic compass reading, GPS, and track layout wherein the method includes the steps of determining a global position and a heading of a locomotive. Upon determining the global position and heading it is necessary to communicate these to a track database disposed in a computer located in a predetermined location. The track database also includes a parallel line substantially identical to a predetermined track layout within the track database for comparing the determined global position and heading to the parallel line for deriving an actual orientation of a locomotive.

### OBJECTS OF THE INVENTION

It is, therefore, one of the primary objects of the present invention to provide a means of determining locomotive orientation based on, magnetic compass reading, GPS, and track layout that determines the orientation of a locomotive on a section of track without requiring motion from the locomotive, of knowledge of the orientation of other locomotives within the consist.

It is also an object of the present invention to provide a means of determining locomotive orientation based on magnetic compass reading, GPS, and track layout that overcomes the shortcomings of existing orientation determination methods in a cost effective manner.

Another object of the present invention is to provide a means of determining locomotive orientation based on magnetic compass reading, GPS, and track layout to determine the “short hood” orientation and reverser status.

Another object of the present invention is to provide a means of determining locomotive orientation based on magnetic compass reading, GPS, and track layout that that is relatively inexpensive to implement.

Another object of the present invention is to provide a means of determining locomotive orientation based on magnetic compass reading, GPS, and track layout that allows for quickly determining a locomotives orientation.

These and various other objects and advantages of this invention will become more readily apparent to those persons skilled in the art after a full reading of the following detailed description, particularly, when such description is read in conjunction with the attached drawings as described below and the appended claims.

### BRIEF DESCRIPTION OF THE DRAWINGS

FIG. 1 is a graphical representation of a track database with a marker indicating the location of a locomotive.

FIG. 2 is a close-up of the locomotive represented by a dot in FIG. 1.

### BRIEF DESCRIPTION OF THE PRESENTLY PREFERRED AND ALTERNATE EMBODIMENTS OF THE INVENTION

Prior to proceeding with the more detailed description of the present invention it should be noted that, for the sake of clarity, identical components, which have identical functions have been designated by identical reference numerals throughout the drawing Figures.

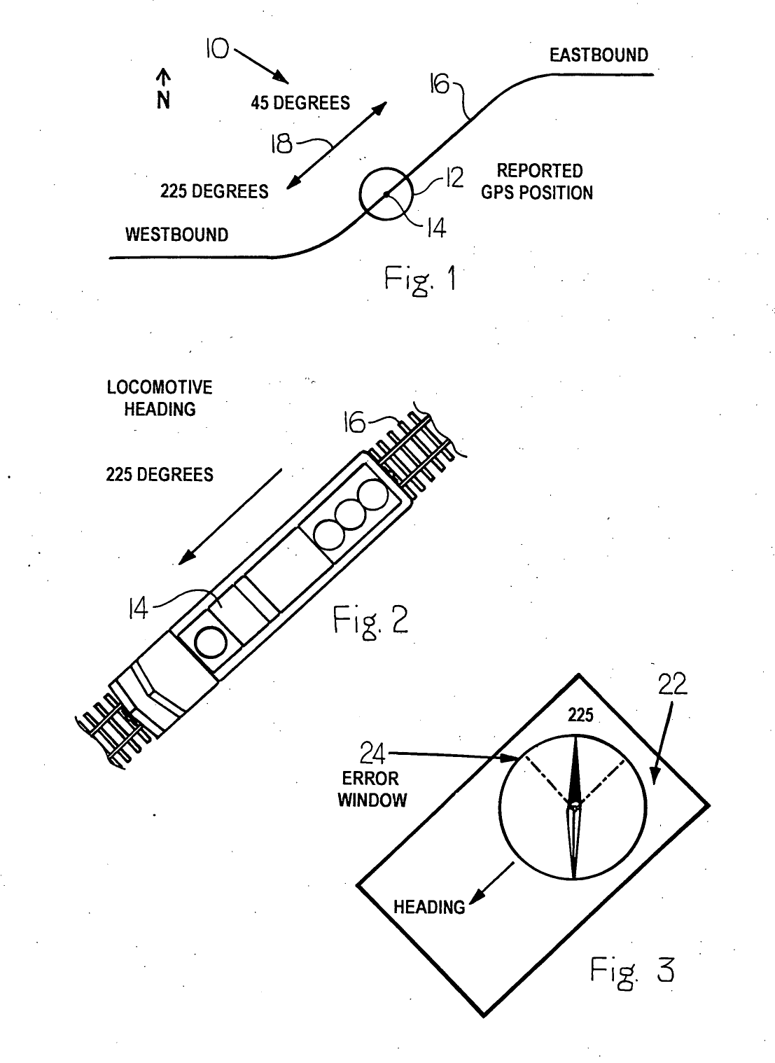

Reference is now made to FIG. 1. FIG. 1 shows a graphical representation of a track database, generally designated 10, with a marker 12 indicating the location of a locomotive 14. That locomotive 14 could either be moving, or stationary and it may or may not be in a train consist with other locomotives. It is assumed that the GPS reported by the locomotive 14 does not necessarily lie exactly upon the location of the track 16. The most likely position, within the uncertainty of GPS, is translated to the track location by finding the marker 12 on the track 16 that lies nearest the reported GPS position of the locomotive 14. That marker 12 is then assumed to be the true location of the locomotive 14. The graphical representation may also be shown in a mathematical representation.

A line 18 is then drawn parallel to the track 16 at the location of the locomotive 14 as shown in FIG. 1. This line 18 represents two potential headings for the locomotive 14. As in the case of FIG. 1 those headings could be either 45° or 225° based upon the locomotive 14 orientation.

FIG. 2 is a close-up of the locomotive 14 represented by a dot in FIG. 1. It can be seen from this,illustration that the locomotive 14 has a true heading of 225°. A heading indicator means, such as the magnetic compass 22 located in the “short hood” end of the locomotive 14, is used to report the measured heading of the front of the locomotive 14, with some errors due to tilt of the earth, soft iron effects, and stray electro-magnetic fields.

Adding or subtracting the appropriated declination angle for a given longitude to correct to true north can reduce magnetic heading errors due to geographic location and corresponding tilt of the earth. Soft iron effects are the distortion to the earths magnetic field caused by nearby ferrous materials such as iron or steel. Soft iron effects can be calibrated out of a measurement as long as the ferrous material, and magnetic compass 22 do not move relative to one another. Magnetic heading errors caused by soft iron effects can then be reduced for use within the known environment. Errors caused by changing electromagnetic fields cannot be calibrated out, but locating the magnetic compass 22 some distance from the locomotive 14 alternator or traction motors can minimize their impact. Regardless of the ability to reduce the contributing errors, it is recognized that tolerance for those errors must be allowed.

In order to allow for the previously stated error sources, the reported heading from the magnetic compass 22 will have an error window applied based upon a preset limit. The system in FIG. 2 could, for example, report a heading of 240° which is 15° off from the true heading of 225°. If an error window of ±45° is applied to a measured heading of 240°, the true heading is determined to lie between 195° and 285°. By the two heading options as derived by correlating the GPS location to a database (45° or 225°) with the possible range of true heading (from 195° to 285°), we can deduce the actual orientation to be 225°.

The actual orientation along the track 16 is then translated into, predetermined nomenclature and may also be displayed on a predetermined source for the locomotive management personnel such as “westbound” as shown in FIG. 1. The predetermined source for displaying the predetermined nomenclature is selected from a group consisting of television monitors, computer displays, wall mounted displays, computer printouts, and portable handheld devices. Generally the predetermined source used is a computer display. The standard heading of “westbound” would finally be conveyed to at least one of an office system where planners could then build a locomotive consist with confidence that the lead locomotive is oriented in the right direction, and a database system onboard the locomotive 14 for use by other systems which require data pertaining the direction of travel.

While both the presently preferred and a number of alternative embodiments of the present invention have been described in detail above it should be understood that various other adaptations and modifications of the present invention can be envisioned by those persons who are skilled in the relevant art without departing from either the spirit of the invention or the scope of the appended claims.

I claim:

1. A method of determining locomotive orientation, said method includes the steps of:
a) determining a global position of a locomotive;
b) determining a heading of such locomotive;
c) communicating said global position as determined in step (a), and said heading as determined in step (b) to a track database disposed in a computer located in a predetermined location;
d) providing a parallel line substantially identical to a predetermined track layout in said track database; and
e) comparing said global position and said heading to said parallel line for determining an actual orientation of such locomotive.

2. A method of determining locomotive orientation, according to claim 1, wherein said heading is determined by a heading indicator means.

3. A method of determining locomotive orientation, according to claim 2, wherein said heading indicator means is a magnetic compass.

4. A method of determining locomotive orientation, according to claim 3, wherein said magnetic compass is located in a short hood end of such locomotive.

5. A method of determining locomotive orientation, according to claim 3, wherein said magnetic compass working in conjunction with said computer allows for a predetermined tolerance for errors in an Earths magnetic field.

6. A method of determining locomotive orientation, according to claim 5, wherein such Earths magnetic field further includes errors due to soft iron effects.

7. A method of determining locomotive orientation, according to claim 5, wherein said predetermined tolerance for errors includes the steps of:
a) at least one of adding and subtracting a predetermined declination angle for said heading; and
b) correcting said heading to a true north for compensating errors due to a corresponding tilt of such Earth.

8. A method of determining locomotive orientation, according to claim 1, wherein such locomotive can be at least one of moving and stationary.

9. A method of determining locomotive orientation, according to claim 8, wherein such locomotive is at least one of a single locomotive and disposed as part of a train consist.

10. A method of determining locomotive orientation, according to claim 1, wherein said track database includes at least one of a graphical representation and a mathematical representation of said predetermined track layout.

11. A method of determining locomotive orientation, according to claim 1, wherein said parallel line represents a predetermined number of potential orientations.

12. A method of determining locomotive orientation, according to claim 11, wherein said predetermined number of potential orientations is at least one.

13. A method of determining locomotive orientation, according to claim 12, wherein said predetermined number of potential orientations is two.

14. A method of determining locomotive orientation, according to claim 1, wherein said track database translates said actual orientation into predetermined nomenclature.

15. A method of determining locomotive orientation, according to claim 14, wherein said predetermined nomenclature is displayed on a predetermined source.

16. A method of determining locomotive orientation, according to claim 15, wherein said predetermined source is selected from a group consisting of television monitors, computer displays, wall mounted displays, computer printouts, and portable handheld devices.

17. A method of determining locomotive orientation, according to claim 16, wherein said predetermined source is from a group of said computer displays.

18. A method of determining locomotive orientation, according to claim 1, wherein said predetermined location is at least one of an office environment and a database system onboard said locomotive.

19. A method of determining locomotive orientation, according to claim 18, wherein said office environment is a control room.

20. A method of determining locomotive orientation, according to claim 1, wherein said actual orientation of such locomotive is communicated to at least one of an office environment and a database system onboard said locomotive.
